(19) United States
(12) Patent Application Publication
(10) Pub. No.: US 2014/0051392 A1
(43) Pub. Date: Feb. 20, 2014

(54) METHOD AND APPARATUS FOR COLLABORATIVE WEB RESOURCE DELIVERY

(71) Applicants: Markus Sakari Isomaki, Espoo (FI); Harri Paloheimo, Espoo (FI); Janne Ofversten, Tampere (FI); Kai Allan Inha, Jarvenpaa (FI)

(72) Inventors: Markus Sakari Isomaki, Espoo (FI); Harri Paloheimo, Espoo (FI); Janne Ofversten, Tampere (FI); Kai Allan Inha, Jarvenpaa (FI)

(73) Assignee: Nokia Corporation, Espoo (FI)

(21) Appl. No.: 13/589,797

(22) Filed: Aug. 20, 2012

(51) Int. Cl. H04W 4/20; H04W 12/06

(52) U.S. Cl. CPC H04W 4/20; H04W 12/06
USPC 455/411; 455/414.3

(57) ABSTRACT

An approach is provided for collaborative web resource delivery. A transaction request platform determines at least one data transaction request from one or more client devices located in a first area with limited or no data coverage. The contextually relevant location platform causes, at least in part, a transmission of the at least one data transaction request to one or more courier devices, wherein the one or more courier devices fulfill the at least one data transaction request when in a second area with data coverage.

### BACKGROUND

Service providers and device manufacturers (e.g., wireless, cellular, etc.) are continually challenged to deliver value and convenience to consumers by, for example, providing compelling network services advancing the underlying technologies. One growing area of interest has been providing adequate internet access in areas with limited or nonexistent reliable network connections or where the cost of transferring large amounts of data across a network is out of reach for potential users, which has resulted in a growing number of users being underserved. As a result, service providers and device manufacturers face significant technical challenges to enabling innovative and user friendly means for interacting and sharing information (e.g., delivery of web resources) within data transaction services. Such means can, for example, lead to greater consumer use and adoption of corresponding services to allow greater access to the Internet.

### Some Example Embodiments

Therefore, there is a need for an approach for collaborative web resource delivery.

According to one embodiment, a method comprises determining at least one data transaction request from one or more client devices located in a first area with limited or no data coverage. The method also comprises causing, at least in part, a transmission of the at least one data transaction request to one or more courier devices. The method further comprises wherein the one or more courier devices fulfill the at least one data transaction request when in a second area with data coverage.

According to another embodiment, an apparatus comprises at least one processor, and at least one memory including computer program code for one or more computer programs, the at least one memory and the computer program code configured to, with the at least one processor, cause, at least in part, the apparatus to determine at least one data transaction request from one or more client devices located in a first area with limited or no data coverage. The apparatus is also caused to causing, at least in part, a transmission of the at least one data transaction request to one or more courier devices. The apparatus is further comprises wherein the one or more courier devices fulfill the at least one data transaction request when in a second area with data coverage.

According to another embodiment, a computer-readable storage medium carries one or more sequences of one or more instructions which, when executed by one or more processors, cause, at least in part, an apparatus to determine at least one data transaction request from one or more client devices located in a first area with limited or no data coverage. The apparatus also causes, at least in part, a transmission of the at least one data transaction request to one or more courier devices. The apparatus is further caused to determine wherein the one or more courier devices fulfill the at least one data transaction request when in a second area with data coverage.

According to another embodiment, an apparatus comprises means for determining at least one data transaction request from one or more client devices located in a first area with limited or no data coverage. The apparatus also comprises means for causing, at least in part, a transmission of the at least one data transaction request to one or more courier devices. The apparatus further comprises means for determining wherein the one or more courier devices fulfill the at least one data transaction request when in a second area with data coverage.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of collaborative web resource delivery, according to one embodiment;

FIG. 2 is a diagram of the components of transaction request platform, according to one embodiment;

FIGS. 3A-3H is a flowchart of a process for collaborative web resource delivery, according to one embodiment;

FIG. 4 is a flowchart of an exemplary schematic for collaborative web resource delivery, according to one embodiment;

FIGS. 5A-5C are diagrams of user interfaces utilized in the processes of FIG. 3, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for collaborative web resource delivery are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

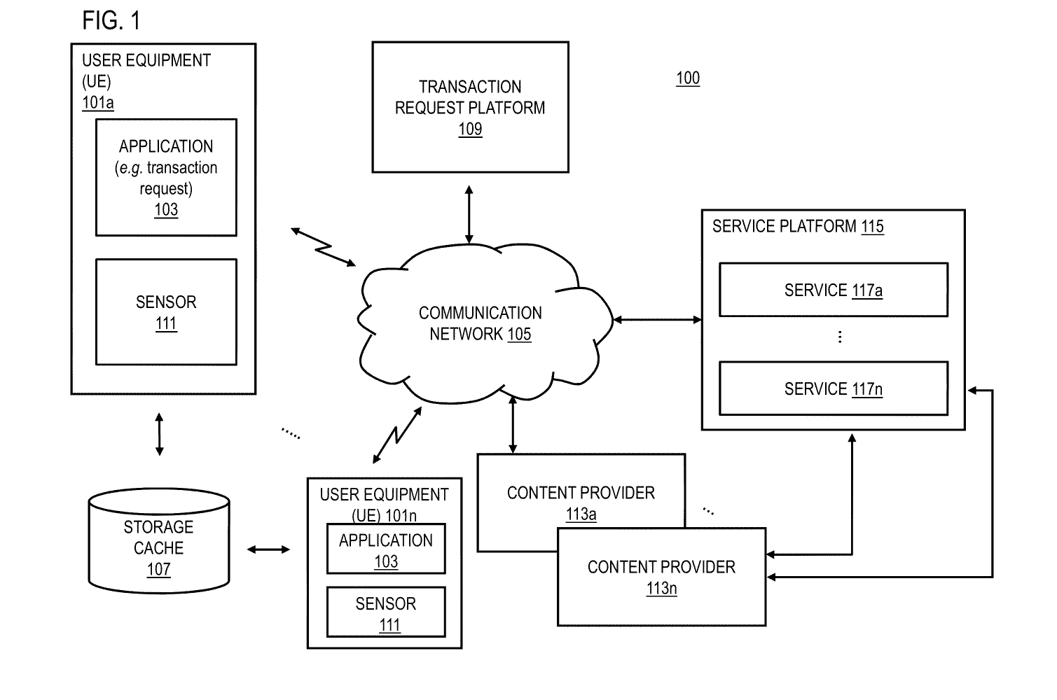

FIG. 1 is a diagram of a system capable of collaborative web resource delivery, according to one embodiment. As discussed above, the need for data transaction services continues to increase. In many locales throughout the world, users do not yet have access to adequate Internet connectivity, and many users cannot afford the exorbitant costs associated with transferring large amounts of data even when access is available. Still, reliance on web-based resources and services is increasing, and in some instances, a necessity of modern life. Users and consumers, for instance, not only want to share information online, but also want to utilize the Internet as a tool readily employed for commerce and community interaction. However, the unpredictable variance in network access, reliability, and associated costs function as a bottleneck to web connectivity, thereby making it difficult for users to participate in all aspects of a web-enabled world.

To address this problem, a system 100 of FIG. 1 introduces the capability to collaboratively deliver web resources in a delay tolerant manner. In one embodiment, a user (i.e., courier) who happens to be in a location having a particular state of data transaction capability (e.g., a Wi-Fi hotspot in a city, local network access, temporary cellular network coverage, etc.) functions act as a proxy for web resource requests previously requested by one or more other users (i.e., clients). As such, at some prior instance, utilizing an available means of transmission, requests from a user could be given to another user for delivery fulfillment, web resources fetched over the Internet when agreed upon data transaction conditions permit, and requests fulfilled via delivery of a web resource from a proxy user to a requesting user. In one embodiment, proxy-based data transaction requires a secure authenticated agreement dictating parameters agreed upon by users as required. In such an agreement, a courier may explicitly agree to carry requests from a client or a client may reject delivery for an already fulfilled request. Further, in some embodiments, a courier may elect to keep an accounting of data transaction metrics (e.g., associated costs of proxy services and functions) for potential future settlement, which may be monetary or transaction-based. In some embodiments, any user may have dual functionality as proxy (e.g., courier) and requester (e.g., client) simultaneously and/or progressively, as conditions permit.

As shown in FIG. 1, the system 100 comprises a user equipment (UE) 101 having connectivity to transaction request platform 109 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 may execute one or more applications 111a-111n (collectively referred to as applications 111). The applications 111 may be any type of application, such as one or more data transaction applications, social networking applications, one or more navigational applications, one or more calendar applications, one or more browsing applications (e.g., Internet browser), etc., or a combination thereof. In one embodiment, one or more applications 111 may perform any one or more of the functions of the transaction request platform 109 discussed below. In one embodiment, UE 101 may employ one or more sensors 111. The sensor 11 may be any type of sensor to implement a data transaction to detect conditions in its vicinity and transforms those detections into physical expression compatible with the measurable phenomenon used to represent information. As such, sensor 111 may function, in part, to configure data transaction associations between one or more couriers, one or more clients, or a combination thereof.

The system 100 may also include a services platform 107 that includes one or more services 109a-109n (collectively referred to as services 109). The services 109 may be any type of service, such as one or more data transaction services, social networking services, one or more navigational services, one or more calendar/temporal services, etc., or a combination thereof. In one embodiment, one or more services 109 may perform any one or more of the functions of the transaction request platform 109. In one embodiment, the transaction request platform 109 may provide a data transaction request from a user to one or more of the services 109 for enhanced functionality.

The system 100 may also include one or more content providers 113a-113n (collectively referred to as content providers 113). The content providers 113 may provide any type of content, such as content related to data transaction requests, social networking, navigation, etc., or a combination thereof.

The system 100 may also include a storage cache 107. The storage cache 107 may be any type of cache capable of storing at least a unit of information associated with one or more data transaction requests from one or more users, at least a unit of information associated with one fulfilled request, at least a unit of information associated with one or more data transaction agreements, or a combination thereof. In some embodiments, storage cache 107 stores information from multiple users simultaneously. In some embodiments, storage cache 107 coordinates with transaction request platform 109 to configure data transactions for cancellation when stale.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, data transaction system users may discover one or more other users in an area or location to initiate a data transaction request. Discovery may employ any existing service and/or discovery mechanism. For instance, services and platforms, such as, but not limited to, peer-to-peer ad-hoc networks, local short-range wireless radios, etc. may serve as a possible means to user discovery. In some embodiments, discovery is not limited to services and/or platforms. User Equipment 101 applications and other available services/platforms, such as, but not limited to, DNS service discovery, Bluetooth Service Discovery, and potential new mechanisms and emerging technologies, for instance, Wi-Fi direct may, at least in part, be employable in user discovery. As such, discovery defines at least two service types: “web-courier” and “web-client”. In one embodiment, a courier discovery may include a client query for at least one “web-courier”. Upon receiving such a query, at least one available courier may respond. In such an embodiment, data transaction participants may employ one or more available UE 101 to UE 101n to proceed with a means of point-to-point connection. In a like manner, client discovery may include a client query for at least one “web-client”.

In one embodiment, a user query may include additional meta-data. Couriers may indicate the timeframe in which they can serve future possible and/or proposed data transaction requests (e.g., I require “X” amount of time to fulfill such a request). In one embodiment, a user may define a timeframe in which a data transaction will become stale or expire (e.g., request must be filled by 3 days, I reserve the right to seek alternative couriers for fulfillment). Such a request may cancel or terminate according to defined data transaction terms. In some embodiments, clients may discover available and/or possible couriers capable of fulfilling a transaction request according to required client parameters. As such, clients may provide a data transfer estimate related to a data transfer request (e.g., web resource “X” will require 1 gigabyte of data transfer). In some embodiments users may define data transaction metrics, terms, agreements, or a combination thereof. In some embodiments, such agreement requirements may be pre-defined, dynamically negotiated, or derivative of past agreements or data transaction participations.

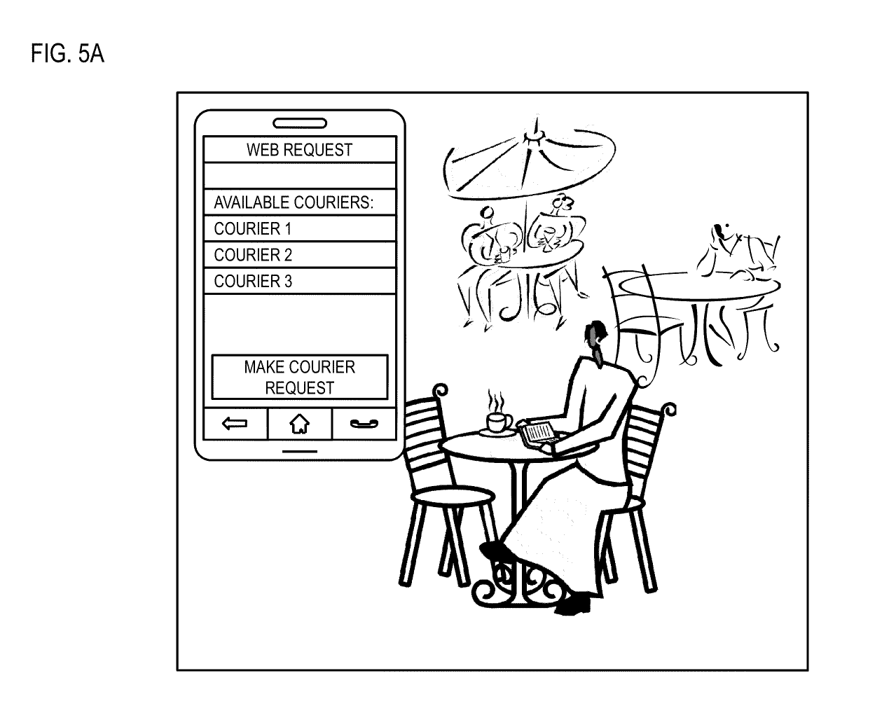

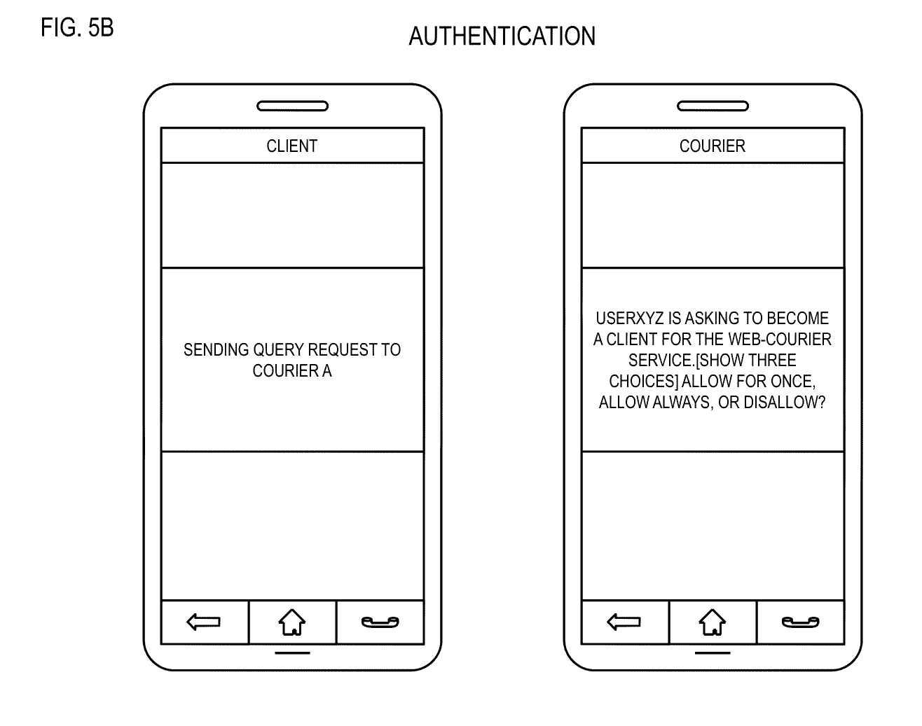

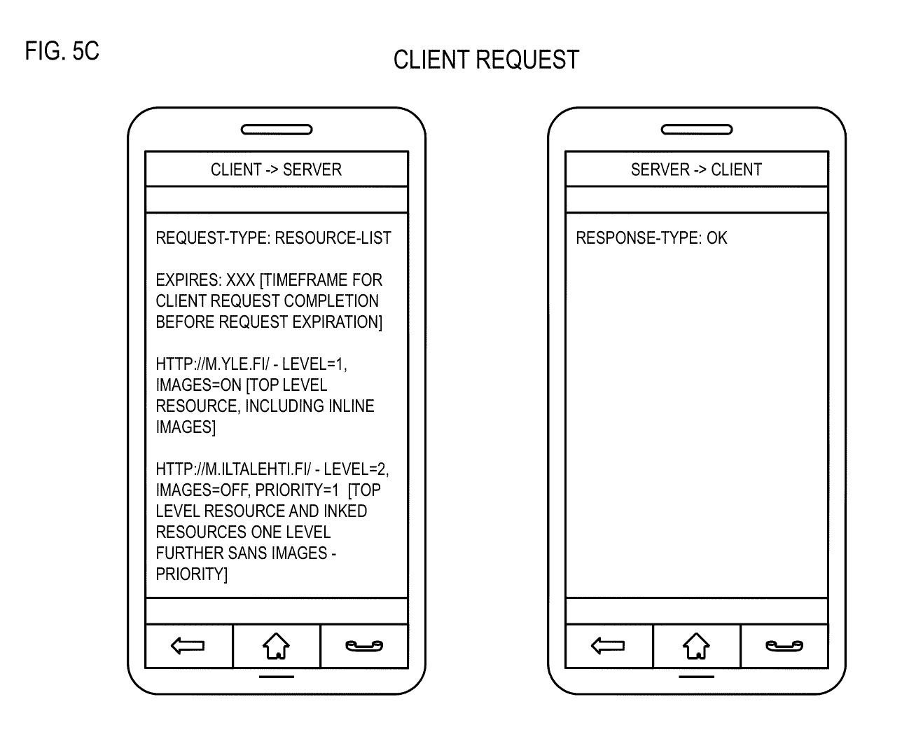

In a further embodiment, users may participate in future and/or current data transactions according to previous data transaction interactions. Such information may be stored, transferred, processed, or a combination thereof by transaction request platform 109. In some embodiments, when a courier and a client lack previous data transaction interaction history, a new association may be required to initiate a data transaction request. As such, existing security mechanisms applicable to device-to-device pairing (security association and/or authentication setup) may be employed. In such a discovery and interaction formation processing, a client and a courier may undertake authentication processing. In such an authentication, devices, components, networks, participants (i.e., users, proxies, organizations, social frameworks, couriers, clients, etc.) may be evaluated for authentication according to defined parameters and/or metrics. In some embodiments, an agreement to serve as a data transaction request participant, client, courier, or a combination thereof may be required. In an exemplary embodiment, as illustrated in FIG. 5B, such a data transaction participation request query may be transmitted via a UE 101 to the UE 101n of one or more users. In some embodiments, upon acceptance and/or approval, when users transmit and/or receive such a data transaction participation request query, a data transaction agreement may be initiated for fulfillment. In some embodiments, upon initiation, completion, fulfillment, or a combination thereof, of such a data transaction agreement, future data transaction participation request queries may not be required. A pre-existing participation history may be recognized by one or more user platforms. In some embodiments, transaction history may be collected and processed to determine trustworthiness characteristics and/or thresholds.

In some embodiments, user transmissions and communication are facilitated via any device-to-device communications framework, services, platforms, or a combination thereof. For example, but not limited to, Bluetooth, Bluetooth Low Energy, and Wi-Fi Direct. Such general transmissions may be completed via TCP/IP, or using a lower-layer communication protocol such as BT-LE attribute protocol. In some embodiments, TCP/IP allows a common mechanism to function in any device-to-device communication technology.

In a further embodiment, a client may send a list of URLs (or URNs) for courier retrieval. A client may indicate a prioritization defining a top-level resource, or also N levels of underlying sub-resources. Further, a client may provide an indication and/or prioritization defining additional elements accessible via a browser-type data transaction framework, such as, the possible inclusion of images in a data transaction request for fulfillment. In some embodiments, data transaction requests may include any such data information, including but not limited to, associated data actions, executable files, applications, etc. In some embodiments, prioritization may be embodied as a prioritized list facilitating a determination of the order in which a courier eventually fetches and/or delivers a data transaction resource. As such, a priority may serve to guarantee that the most relevant data transaction requests are serviced and/or fulfilled prior to one or more other data transaction requests.

In some embodiments, upon the completion of a fulfilled data transaction request, a courier may store a client identifier, a data transaction request expiration period (determined by a possible staleness threshold), and a data transaction resource list, to be acted upon when one or more couriers are in range of an adequate Internet connection, as defined by user parameters. In some embodiments, a data transaction system requires a user input to trigger one or more action processes.

In some embodiments, a courier may function instead as client for a previous data transaction participant, according to a defined agreement. User participation as either clients or couriers may be dynamic. As such, a courier possessing a resource list of a client may fluctuate, at some point taking on the data transaction role of a client. In such an exemplary scenario, such a user may forward an element of a data transaction request or resource list to one or more other users to function as couriers. In some embodiments, transaction request platform 109 functions to protect the privacy of an original requesting client. In some embodiments, data transaction requests, resource lists, or a combination thereof, may include metadata functioning as a forwarding setting, applicable to marked transaction requests.

In a further embodiment, a courier may have an associated setting defining whether transmitting a stored data transaction request may be manual or automatic. In some embodiments, manual data transaction requests may require a user input functioning as a trigger to deploy one or more data transaction processes. As such, an automatic data transaction request may trigger upon one or more users attaining particular data transaction parameters (e.g., courier 1 is now located in an area having a data transfer rate of “X” megabytes per second). For example, a data transaction request may be acted on when a User Equipment 101 attains Internet access via a particular network. Various network parameter requirements may be defined by a user depending on the inclinations of a user, such as, but not limited to, cost, reliability, security, power consumption, data transfer rate, trustworthiness, or a combination thereof.

In one embodiment, a data transaction system may employ security measures, such as, but not limited to, encryption. As such, an extension allows client fulfillment while limiting courier access to the particulars of a data transaction request, the delivered fulfilled response, or a combination thereof. As such, a client may employ an Internet based server, with which it has a secret key (shared key or public/private key pair). A client may not provide its resource list to a courier in plain text, but rather, provisions are encrypted with a key, so the courier is not granted permission to access information relating to an information transaction request, a web resource list, or its associated payload delivery. A courier may only be granted access to collect information relating to an Internet server's address, and general means of communication. In such a system, a courier may send an encrypted list to a server, wherein a server decrypts the list and fetches the relevant resources. The server may then encrypt the responses, and sends them as encrypted responses to the courier. As such, a courier may then deliver this encrypted content to a client for possible decryption.

In some embodiments, a server may also be employed to improve the efficiency of communication. A client may have a predefined resource list on a server, so the client only needs to give the courier a reference to this list (e.g., “server-list-X”), or a list plus additional individual items. The communication between a courier and a server may be compressed. It may be possible for a client to manage a server-based list via a courier, for instance by sending add and delete commands for new items, for example: “server-list-X & ADD=“http://m.iltalehti.fi”.

By way of example, the UE 101a-101n, the transaction request platform 109, the transaction request applications 103, the service platform 115, the content providers 113, and the storage cache 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

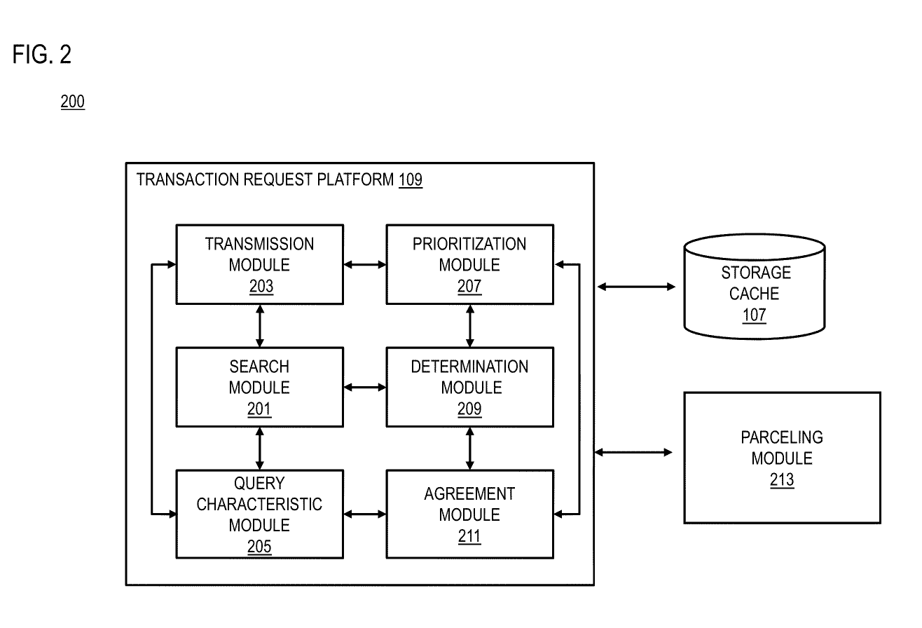

FIG. 2 is a diagram of the components of transaction request platform, according to one embodiment. By way of example, the transaction request platform includes one or more components for providing collaborative web resource delivery. It is contemplated that the functions of these components may be combined in one or more components or performed by other components of equivalent functionality. In this embodiment, the transaction request platform includes a search module 201, a transmission module 203, a query characteristic module 205, a prioritization module 207, determination module 209, an agreement module 211, and a parceling module 213.

In one embodiment, the search module 201 facilitates clients and/or couriers determine the communicative presence of other data transaction users within a particular range. Further, search module 201 causes, at least in part, a search for one or more available clients, a search for one or more available couriers, or a combination thereof. In some embodiments, search module 201 is configured to query for ad hoc clients, authenticated clients, ad hoc couriers, authenticated couriers, or a combination thereof. Further, search module 201 functions coordinately with transaction request platform 109 in a user authentication processing.

In one embodiment, the transmission module 203 functions coordinately with transaction request platform 109, application 103, or a combination thereof to cause, at least in part, a transmission of a data transaction request to one or more courier devices. In further embodiments, transmission module 203 is configured to execute fulfillment of a data transaction request when a courier is in an area having adequate data coverage as defined, in part, by user transaction agreements via query characteristic module 205. As such, transmission module 203 functions coordinately in a transmission of information between users, data transaction participants, proxies, couriers, clients, or a combination thereof, in a short-range or extended-range manner.

In one embodiment, the query characteristic module 205 function coordinately with transaction request platform 109, search module 201, and transmission module 203 to execute fulfillment of a data transaction request according to a transaction agreement as defined by one or more users, components, services, or a combination thereof. In some embodiments, query characteristic module 205 is employable via network components in a user authentication processing.

In one embodiment, the prioritization module 207 executes a prioritization of the at least one data transaction request to determine, at least in part, an order in which the one or more couriers fetch one or more web resources. In such an embodiment, prioritization may apply to delivery of a particular web resource, a particular data transaction, a particular user, a set or list of web resources, a set or list of data transactions, a set or list of users, or a combination thereof.

In one embodiment, the determination module 209 functions coordinately with multiple network components, modules, and platforms. Determination module 209 determines at least one data transaction request from one or more client devices located in a first area with limited or no data coverage. Further, a location having limited or no data coverage can be defined by data transaction users, employable via determination module 209, that function, in part, to determine the state of data transaction availability.

In some embodiments, determination module 209 facilitates a determination of one or more trustworthiness characteristics, one or more past transaction history characteristics, one or more timeframe characteristics, one or more data transfer characteristics, one or more settlement characteristics, or a combination thereof. Further, determination module 209 facilitates a determination of the one or more courier devices, one or more client devices, or a combination thereof in an area with data coverage. In some embodiments, determination module 209 functions, at least in part, to facilitate a determination of data coverage parameters including data rate threshold, communication cost threshold, power consumption threshold, trustworthiness threshold, or a combination thereof.

In some embodiments, limited data coverage may include any data coverage and/or transfer limitations as defined by one or more users. Limited data coverage may include, but is not limited to, data coverage parameters and/or limitations according to data rate threshold, communication cost threshold, power consumption threshold, trustworthiness threshold, or a combination thereof. As such, limited data coverage may include data coverage availabilities wherein the data transfer rate is not acceptable (e.g., data transfer rate is too slow), data transfer is too costly, data coverage requires too much energy, clients and/or couriers not acceptably trustworthy, or a combination thereof, as defined by user requirements and/or system requirements.

In one embodiment, facilitated by determination module 209 may facilitate user agreements. Further, account information may be utilized by determination module 209 as an identifier of a data transaction participant. In some embodiments, determination module 209 and transaction request platform 109 function coordinately to determine, at least in part, a fulfillment timeframe and may function to calculate, in part, settlement ramifications of late or subsequent fulfillment attempts by late-acting users.

In one embodiment, the agreement module 211 executes an agreement between a set of users, defining parameters associated with a data transaction. Agreements may be defined by one or more users or network participants, or may be flexible and generated dynamically depending on fulfillment parameters.

In one embodiment, the parceling module 213 executes a parceling of the at least one data transaction request, a parceling of at least one data transaction fulfillment, or a combination thereof. In one embodiment, parceling is based, at least in part, on a discrete packaging of data units among the one or more clients, the one or more couriers, or a combination thereof. In some embodiments parceling module 213 may function coordinately with transaction request platform 109 to determine the most efficient manner to execute a data transaction considering available user resources. In some embodiments, data transaction requests may be transmitted via transmission module 203 to a set of couriers. In such an embodiment, parceling module 213 may divide fulfillment amongst available couriers while maximizing delivery characteristics, transaction parameters and metrics, such as, but not limited to, efficiency, cost, quality, security, or a combination thereof.

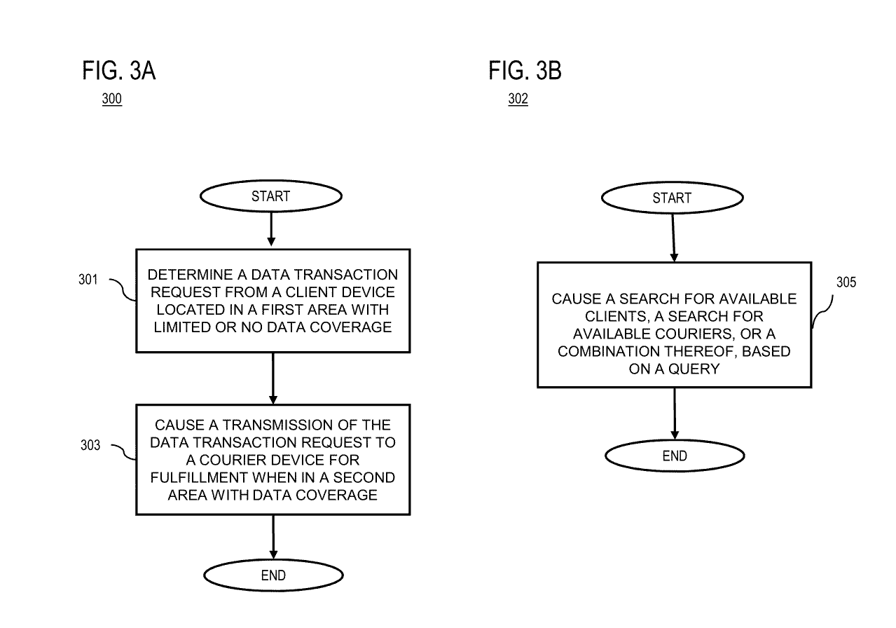

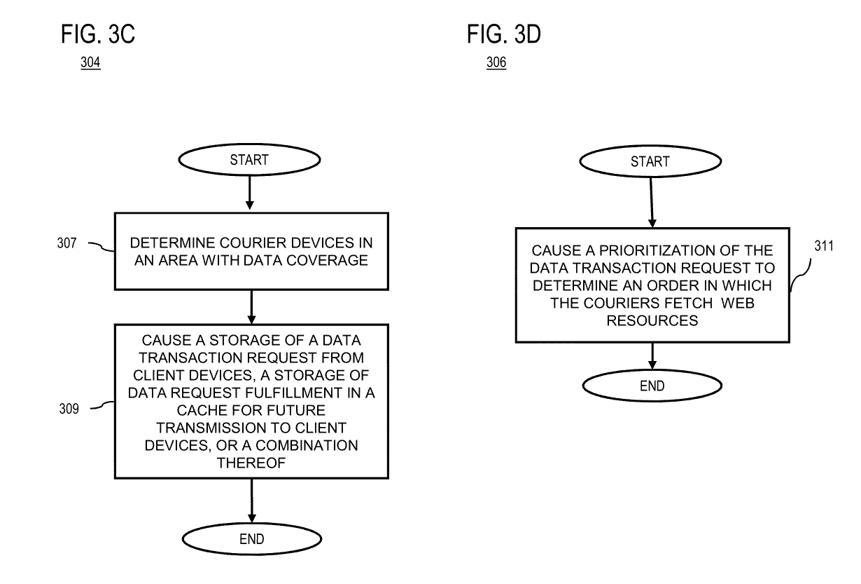

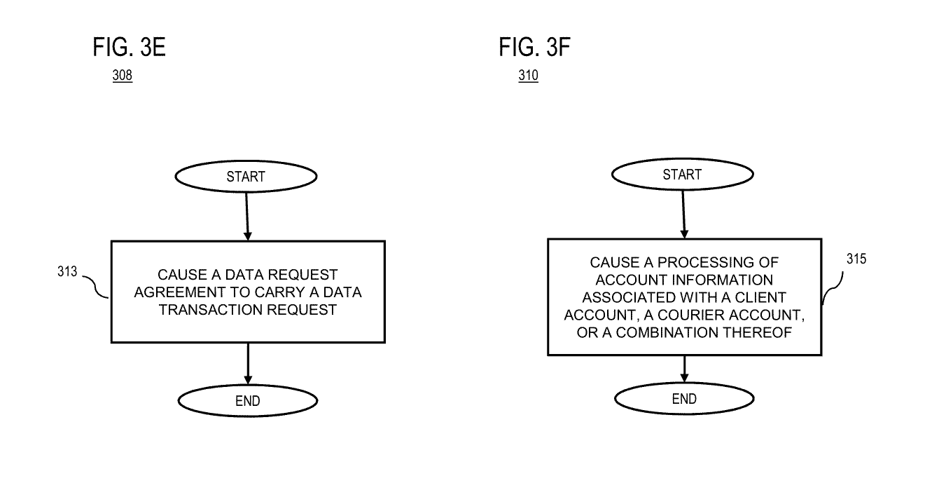

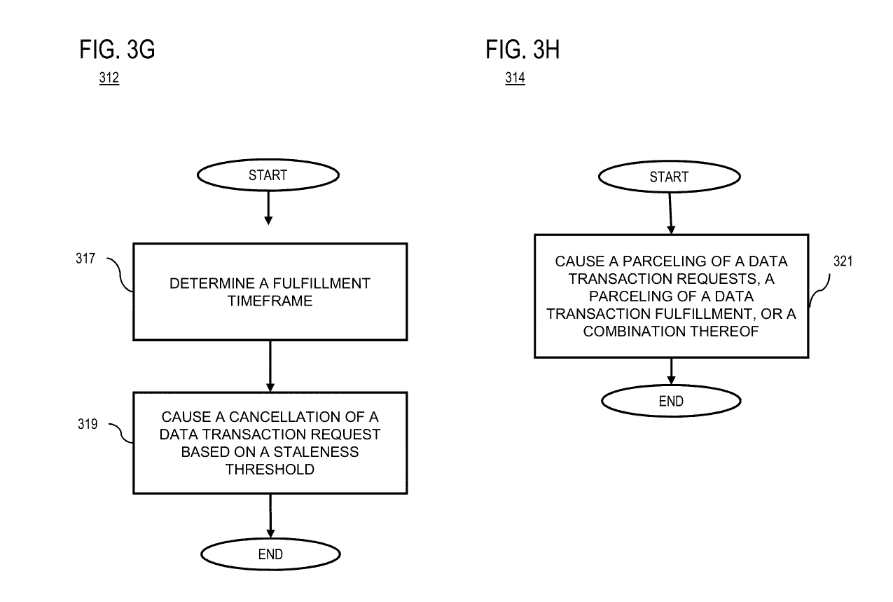

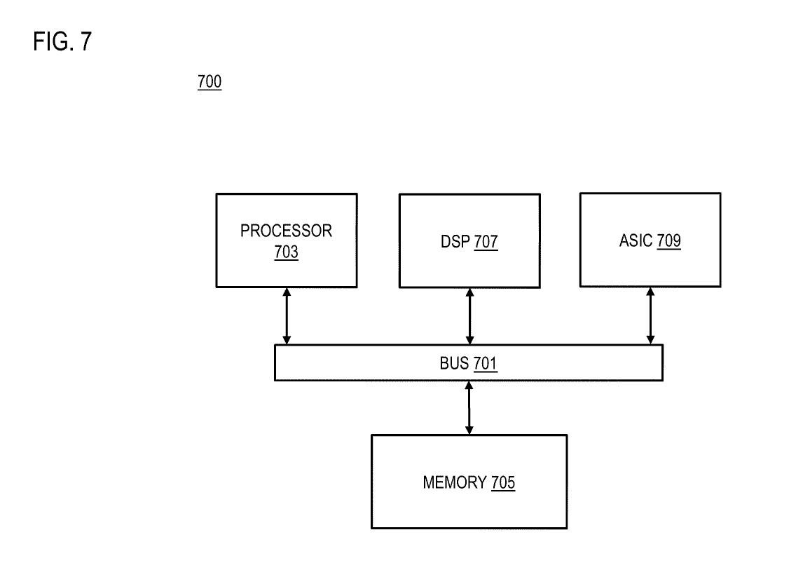

FIG. 3 is a flowchart of a process for collaborative web resource delivery, according to one embodiment. In one embodiment, the transaction request platform 109 performs the process 300 and is implemented in, for instance, a chip set including a processor and a memory as shown in FIG. 7. In addition or alternatively, the transaction request application 103 may perform all or a portion of the process 300.

In step 301, determination module 209 facilitates a determination of at least one data transaction request from one or more client devices located in a first area with limited or no data coverage. In some embodiments, limited or no data coverage can be defined by data transaction users, employable via determination module 209, that function, in part, to determine the state of data transaction availability. Determination module 209 is configured in a searchable mode, in conjunction with search module 201, to assist clients and/or couriers determine the communicative presence of other data transaction users in at least a first area.

In step 303, transmission module 203 causes, at least in part, a transmission of the at least one data transaction request to one or more courier devices. Further transmission module 203 is configured to execute fulfillment of a data transaction request when a courier is in an area having adequate data coverage as defined, in part, by user transaction agreements via query characteristic module 205.

In step 305, search module 201 causes, at least in part, a search for one or more available clients, a search for one or more available couriers, or a combination thereof. Search module 201 is configured to query for ad hoc clients, authenticated clients, ad hoc couriers, authenticated couriers, or a combination thereof. In some embodiments, authentication is dependent upon user-defined parameters according to the characteristics and merits of potential data transaction users for potential data transaction agreements. In some further embodiments, authentication may be dependent on security characteristics, past data transaction outcomes, past agreements, or a combination thereof. In some embodiments, ad hoc data transaction participants are elected, chosen, defined, denied, or a combination thereof, dynamically according to user configuration.

In some embodiments, the various characteristics are defined, determined, allowed, agreed upon, bargained for, or a combination thereof according to data transaction users. Determination module 209 facilitates a determination of one or more trustworthiness characteristics, one or more past transaction history characteristics, one or more timeframe characteristics, one or more data transfer characteristics, one or more settlement characteristics, or a combination thereof.

In an exemplary embodiment, timeframe characteristics are configured according to a period of time in which a data request must be conveyed, processed, transferred, fulfilled, or a combination thereof. Users may agree upon acceptable timeframe characteristics in which a courier may fulfill a data request, potentially for future settlement. In some embodiments, a request may be cancelled if not fulfilled according to a defined timeframe. In some embodiments, cancelled data transaction requests are deemed stale according to user parameters and may be communicated to one or more users as such (e.g., Client “X” no longer requires request fulfillment, because the request was not fulfilled timely, or, the data has been attained by alternative means).

In an exemplary embodiment, data transfer characteristics are configured according to a data rate defining a bit rate, or the number of bits that are conveyed or processed per unit of time. Users may agree upon acceptable data transfer characteristics in which a courier may fulfill a data request, potentially for future settlement.

In an exemplary embodiment, settlement characteristics may define a maximum monetary allotment per request, per number of bits conveyed and/or processed and/or transferred, or a combination thereof. Users may agree upon an acceptable settlement in which a courier may fulfill a data request, potentially for future settlement.

In an exemplary embodiment, trustworthiness may define a measure associated with a trust framework as defined by data transaction users. Users may agree upon acceptable trustworthiness characteristics in which a courier may fulfill a data request, potentially for future settlement. Trust framework may be defined according to the trustworthiness and/or reliability attribute of user, component, device, network, or organization that provides confidence to other users of the qualifications, capabilities, and reliability of that user to perform specific tasks and fulfill assigned responsibilities. Determination of trustworthiness may be based on the assurance or grounds for confidence that user has met the requirements of past data transaction request interactions (according to past transaction history characteristics) as defined user-to-user, across a community, across a social networking platform, or a combination thereof.

In step 307, determination module 209 facilitates a determination of the one or more courier devices are in an area with data coverage. In some embodiments, limited or no data coverage can be defined by data transaction users, employable via determination module 209, that function, in part, to determine the state of data transaction availability.

In step 309, transaction request platform 109 causes, at least in part, a storage of at least one data transaction request from the one or more client devices, a storage of at least one data request fulfillment in at least one cache for future transmission to the one or more client devices, or a combination thereof. In some embodiments, transaction request platform 109 functions coordinately with storage cache 107 to store elements of a data transaction request. In some embodiments, determination module 209 functions, at least in part, to facilitate a determination of data coverage parameters including data rate threshold, communication cost threshold, power consumption threshold, trustworthiness threshold, or a combination thereof.

In some embodiments, the various thresholds are defined, determined, allowed, agreed upon, bargained for, or a combination thereof according to data transaction users. In an exemplary embodiment, data rate may define a bit rate, or the number of bits that are conveyed or processed per unit of time. Users may agree upon an acceptable data rate threshold in which a courier may fulfill a data request, potentially for future settlement.

In an exemplary embodiment, communication cost may define a maximum monetary allotment per request, per number of bits conveyed and/or processed and/or transferred, or a combination thereof. Users may agree upon an acceptable communication cost threshold in which a courier may fulfill a data request, potentially for future settlement.

In an exemplary embodiment, power consumption may define a maximum allowable electrical output per request, per number of bits conveyed or processed, or a combination thereof as measured, for example, in Kilowatt hour, or like unit of energy. Users may agree upon an acceptable power consumption threshold in which a courier may fulfill a data request, potentially for future settlement.

In an exemplary embodiment, trustworthiness may define a measure associated with a trust framework as defined by data transaction users. Users may agree upon an acceptable trustworthiness threshold in which a courier may fulfill a data request, potentially for future settlement. Trust framework may be defined according to the trustworthiness and/or reliability attribute of user, component, device, network, or organization that provides confidence to other users of the qualifications, capabilities, and reliability of that user to perform specific tasks and fulfill assigned responsibilities. Determination of trustworthiness may be based on the assurance or grounds for confidence that user has met the requirements of past data transaction request interactions as defined user-to-user, across a community, across a social networking platform, or a combination thereof.

In step 311, prioritization module 207 causes, at least in part, a prioritization of the at least one data transaction request to determine, at least in part, an order in which the one or more couriers fetch one or more web resources.

In step 313, agreement module 211 causes, at least in part, at least one data request agreement to carry the at least one data transaction request. In one embodiment, agreements may be automatic, facilitated by determination module 209, according to a pre-defined set of user parameters, case-by-case according to dynamic user communications, according to user input selection via a determination module 209 presented list of available users in range, or a combination thereof.

In step 315, transaction request platform 109 and agreement module 211 function coordinately to cause, at least in part, a processing of at least one account information associated with the at least one client account, the at least one courier account, or a combination thereof. Such account information may be utilized by determination module 209 as an identifier of a data transaction participant. Further, account information may represent fulfillment metrics used, at least in part, in the calculation of transaction fulfillment settlement. Account information may be collected via storage cache 107 for future settlement.

In step 317, determination module 209 and transaction request platform 109 function coordinately to determine, at least in part, a fulfillment timeframe. In an exemplary embodiment, a fulfillment timeframe is configured according to a period of time in which a data request must be conveyed, processed, transferred, fulfilled or a combination thereof. Users may agree upon fulfillment timeframe in which a courier may fulfill a data request, potentially for future settlement. In some embodiments, a request may be cancelled (step 319) if not fulfilled, for example, according to an agreed upon fulfillment timeframe. In some embodiments, cancelled data transaction requests are deemed stale according to user parameters and may be communicated to one or more users as such. In some embodiments, such cancelled stale data transaction requests may or may not incur any settlement requirements.

In step 321, parceling module 213 causes, at least in part, a parceling of the at least one data transaction requests, a parceling of at least one data transaction fulfillment, or a combination thereof. In one embodiment, parceling is based, at least in part, on a discrete packaging of data units among the one or more clients, the one or more couriers, or a combination thereof. As such, transaction requests and delivery fulfillment may be parceled into discrete data units among one or more data transaction users coordinately via parceling module 213.

In some embodiments, transaction requests and delivery fulfillment packages are divided proportionately among users, divided according to user parameters, or a combination thereof. For example, one data transaction may be parceled into component parts to form a complete data transaction delivery fulfillment. In some embodiments, multiple users may act on the same or similar components of a single data transaction. As such, client fulfillment may depend, at least in part, on the first courier to transmit delivery to a client. In such an embodiment, subsequent couriers may be barred from transmitting an already fulfilled request, completely or partially. As such, determination module 209 may function to calculate, in part, settlement ramifications late, or subsequent fulfillment attempts by late acting users.

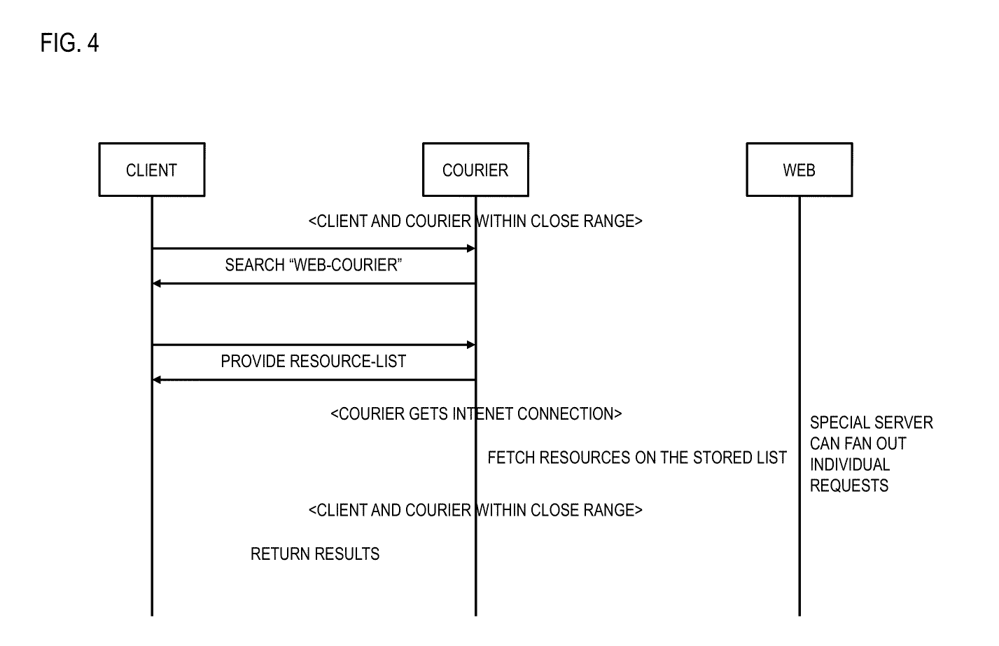

FIG. 4 is a flowchart of a general exemplary schematic for collaborative web resource delivery, according to one embodiment. In one embodiment, a user (i.e., courier) who happens to be in a location having a particular state of data transaction capability (e.g., a Wi-Fi hotspot in a city, local network access, temporary cellular network coverage, etc.) functions as a proxy for web resource requests previously requested by one or more other users (i.e., clients). As such, at some prior instance, utilizing an available means of transmission, requests from a user could be given to another user for delivery fulfillment, web resources fetched over the Internet when agreed upon data transaction conditions permit, and requests fulfilled via delivery of a web resource from a proxy user to a requesting user. In one embodiment, proxy-based data transaction requires a secure authenticated agreement dictating parameters agreed upon by users as required. In such an agreement, a courier may explicitly agree to carry requests from a client. Further, in some embodiments, a courier may elect to keep an accounting of data transaction metrics (e.g., associated costs of proxy services and functions) for potential future settlement. In some embodiments, any user may have dual functionality as proxy (e.g., courier) and requester (e.g., client) simultaneously and/or progressively, as conditions permit.

FIGS. 5A-5C are diagrams of user interfaces utilized in the processes of FIG. 3, according to various embodiments. In one embodiment, as depicted in FIG. 5A, data transaction users may discover one or more other users in an area or location for collaborative web delivery. Discovery may employ any existing service and/or discovery mechanism. Data transaction platform 109 may function coordinately with determination module 209 to discover available couriers within a client's range. A user interface may be triggered by transaction request platform 109 to present available couriers for a possible data transaction request. As such, a client may trigger transmission of at least one data transaction request to one or more couriers via transaction request platform 109. In some embodiments, transaction request platform 109 may provide further information regarding available users, including, but not limited to, identification information, past transaction history, delivery fulfillment metrics, trustworthiness elements, or a combination thereof. In some embodiments, user input operating as a trigger to a data transaction request is not required. Instead, a data transaction request is initiated immediately upon coming within range of an available user meeting adequate requirements.

In an exemplary embodiment, an authentication determination, as illustrated in FIG. 5B, includes a data transaction participation request query transmitted via a UE 101 to the UE 101 of one or more users. Users may participate in future and/or current data transactions according to previous data transaction interactions. Such information may be stored, transferred, processed, or a combination thereof by transaction request platform 109. In some embodiments, when a courier and a client do not have any previous data transaction interaction, a new association may be required to initiate a data transaction request. As such, existing security mechanisms applicable to device-to-device pairing (security association setup) may be employed. In such a discovery and interaction formation processing, a client and a courier may undertake authentication processing. In such an authentication, devices, components, networks, participants (i.e., users, proxies, organizations, social frameworks, couriers, clients, etc.) may be evaluated for authentication according to defined parameters and/or metrics. In some embodiments, an agreement to serve as a data transaction request participant, as a client, courier, or a combination may be required. In an exemplary embodiment, as illustrated in FIG. 5B, such a data transaction participation request query may be transmitted via a UE 101 to the UE 101 of one or more users. In some embodiments, upon acceptance and/or approval users transmitting and/or receiving such a data transaction participation request query, a data transaction agreement may be initiated for fulfillment.

FIG. 5C, depicts an exemplary client request including a resource list. In one embodiment, a client may send a list of URLs (or URNs) for courier retrieval. A client may indicate a prioritization defining a top-level resource, or also N levels of underlying sub-resources. Further, a client may provide an indication and/or prioritization defining additional elements accessible via a browser-type data transaction framework, such as the possible inclusion of images in a data transaction request for fulfillment. In some embodiments, data transaction requests may include any such data information, including but not limited to, associated data actions, executable files, applications, etc. In some embodiments, prioritization may be embodied as a prioritized list employable a determination of the order in which a courier eventually fetches and/or delivers a data transaction resource. As such, a priority may serve to guarantee that the most relevant data transaction requests are serviced and/or fulfilled prior to one or more other data transaction request.

One such exemplary data transaction request, as depicted in FIG. 5C, may include:

client->server:
Request-type: Resource-List
Expires: xxx <- this tells how long the client wishes the resource list to be
valid. If the courier can't fetch the resources early enough, the list may
expire, according to user parameters.
http://m.yle.fi/ - level=1, images=on <- this refers just to the top level
resource, including inline images
http://m.iltalehti.fi/ - level=2, images=off, priority=1 <- this refers to
the top level resource and all resources that are linked from that resource,
but only one level further, without any images, with high (relative) priority
server->client
Response-type: OK

Error responses would include “too many items on the resource list”, “max=10”, after which the client could reduce the number of list items to max.

The processes described herein for collaborative web resource delivery may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

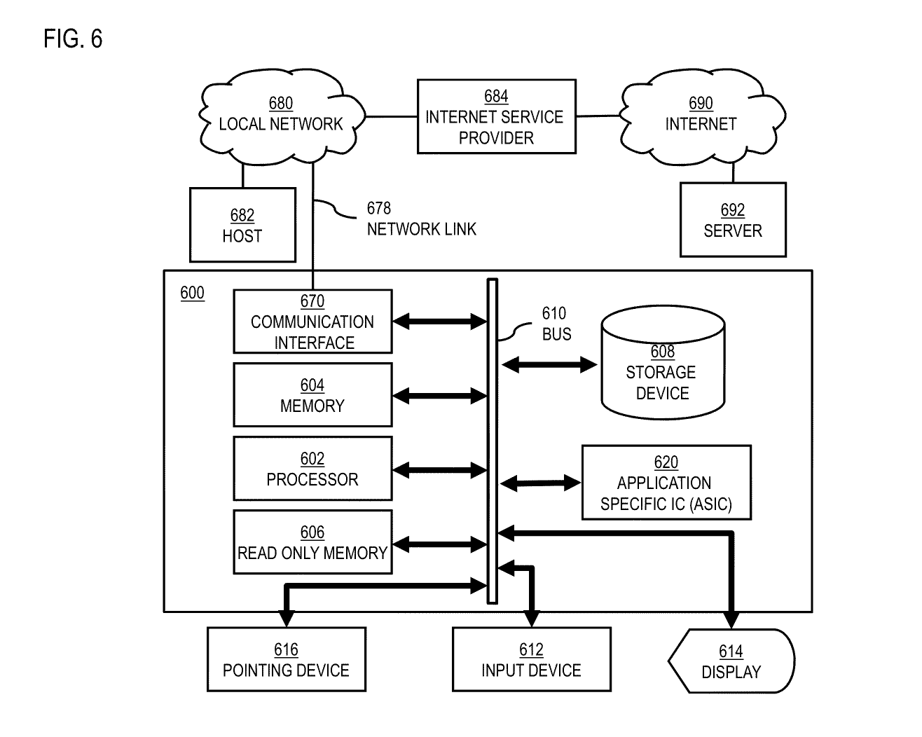

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to collaborative web resource delivery as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of collaborative web resource delivery.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to collaborative web resource delivery. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for collaborative web resource delivery. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for collaborative web resource delivery, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for collaborative web resource delivery to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to collaborative web resource delivery as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of collaborative web resource delivery.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to collaborative web resource delivery. The memory 705 also stores the data associated with or generated by the execution of the inventive steps.

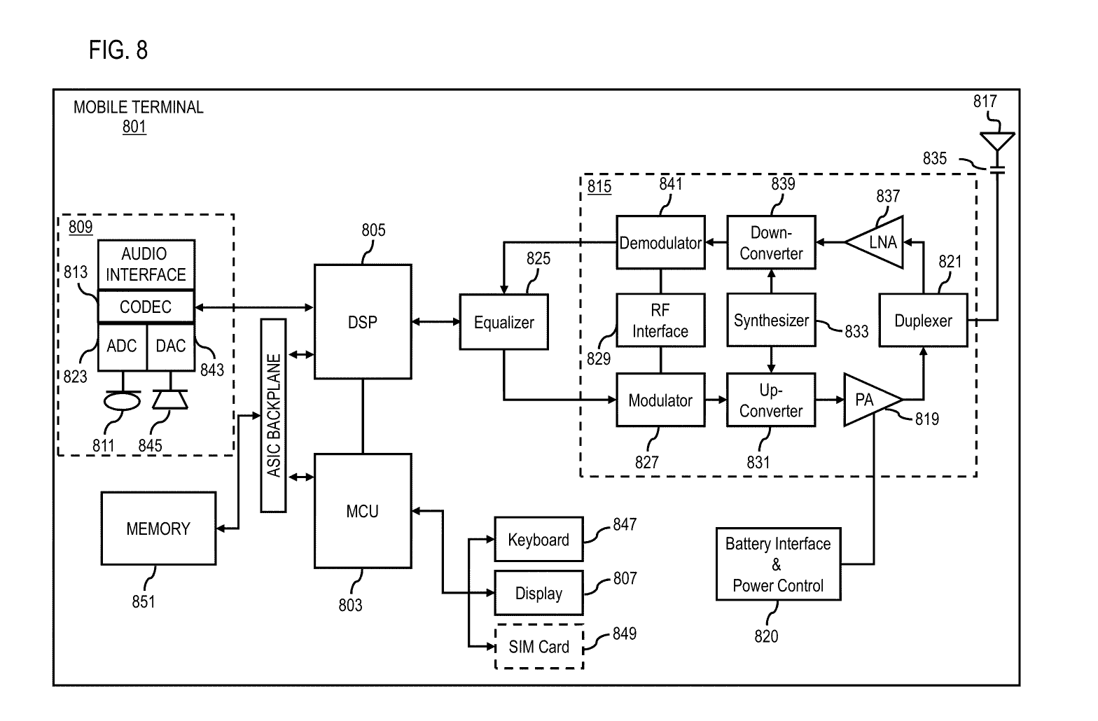

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of collaborative web resource delivery. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of collaborative web resource delivery. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to collaborative web resource delivery. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination at least one data transaction request from one or more client devices located in a first area with limited or no data coverage; and
a transmission of the at least one data transaction request to one or more courier devices,
wherein the one or more courier devices fulfill the at least one data transaction request when in a second area with data coverage.

2. A method of claim 1, wherein the (1) data and/or (2) information and/or (3) at least one signal are further based, at least in part, on the following:
a search for one or more available clients, a search for one or more available couriers, or a combination thereof,
wherein the search is based, at least in part, on a query for ad hoc clients, a query for authenticated clients, a query for ad hoc couriers, a query for authenticated couriers, or a combination thereof.

3. A method of claim 2, wherein the query for ad hoc clients, the query for authenticated clients, the query for ad hoc couriers, the query for authenticated couriers, or a combination thereof include, at least in part, one or more trustworthiness characteristics, one or more past transaction history characteristics, one or more timeframe characteristics, one or more data transfer characteristics, one or more settlement characteristics, or a combination thereof.

4. A method of claim 1, wherein the data transaction request includes, at least in part, a list of one or more web resources to be accessed by the one or more couriers.

5. A method of claim 1, wherein the (1) data and/or (2) information and/or (3) at least one signal are further based, at least in part, on the following:
a prioritization of the at least one data transaction request to determine, at least in part, an order in which the one or more couriers fetch one or more web resources.

6. A method of claim 1, wherein the (1) data and/or (2) information and/or (3) at least one signal are further based, at least in part, on the following:
at least one determination of the one or more courier devices are in an area with data coverage; and
a storage of at least one data transaction request from the one or more client devices, a storage of at least one data request fulfillment in at least one cache for future transmission to the one or more client devices, or a combination thereof,
wherein data coverage parameters include a data rate threshold, a communication cost threshold, a power consumption threshold, a trustworthiness threshold, or a combination thereof.

7. A method of claim 1, wherein the (1) data and/or (2) information and/or (3) at least one signal are further based, at least in part, on the following:
at least one data request agreement to carry the at least one data transaction request.

8. A method of claim 1, wherein the (1) data and/or (2) information and/or (3) at least one signal are further based, at least in part, on the following:
a processing of at least one account information associated with the at least one client account, the at least one courier account, or a combination thereof,
wherein the at least one account information is based, at least in part, on an amount of data transferred for potential future settlement.

9. A method of claim 1, wherein the (1) data and/or (2) information and/or (3) at least one signal are further based, at least in part, on the following:
a parceling of the at least one data transaction requests, a parceling of at least one data transaction fulfillment, or a combination thereof,
wherein the parceling is based, at least in part, on a discrete packaging of data units among the one or more clients, the one or more couriers, or a combination thereof.

10. A method of claim 1, wherein the (1) data and/or (2) information and/or (3) at least one signal are further based, at least in part, on the following:
at least one determination of at least one fulfillment timeframe; and
a cancellation of the least one data transaction request based, at least in part, on the fulfillment timeframe.

11. An apparatus comprising:
at least one processor; and
at least one memory including computer program code for one or more programs,
the at least one memory and the computer program code configured to, with the at least one processor, cause the apparatus to perform at least the following,
determine at least one data transaction request from one or more client devices located in a first area with limited or no data coverage; and
cause, at least in part, a transmission of the at least one data transaction request to one or more courier devices,
wherein the one or more courier devices fulfill the at least one data transaction request when in a second area with data coverage.

12. An apparatus of claim 11, wherein the apparatus is further caused to:
cause, at least in part, a search for one or more available clients, a search for one or more available couriers, or a combination thereof,
wherein the search is based, at least in part, on a query for ad hoc clients, a query for authenticated clients, a query for ad hoc couriers, a query for authenticated couriers, or a combination thereof.

13. An apparatus of claim 12, wherein the query for ad hoc clients, the query for authenticated clients, the query for ad hoc couriers, the query for authenticated couriers, or a combination thereof include, at least in part, one or more trustworthiness characteristics, one or more past transaction history characteristics, one or more timeframe characteristics, one or more data transfer characteristics, one or more settlement characteristics, or a combination thereof.

14. An apparatus of claim 11, wherein the data transaction request includes, at least in part, a list of one or more web resources to be accessed by the one or more couriers.

15. An apparatus of claim 11, wherein the apparatus is further caused to:
cause, at least in part, a prioritization of the at least one data transaction request to determine, at least in part, an order in which the one or more couriers fetch one or more web resources.

16. An apparatus of claim 11, wherein the apparatus is further caused to:
determine the one or more courier devices are in an area with data coverage; and
cause, at least in part, a storage of at least one data transaction request from the one or more client devices, a storage of at least one data request fulfillment in at least one cache for future transmission to the one or more client devices, or a combination thereof,
wherein data coverage parameters include a data rate threshold, a communication cost threshold, a power consumption threshold, a trustworthiness threshold, or a combination thereof.

17. An apparatus of claim 11, wherein the apparatus is further caused to:
cause, at least in part, at least one data request agreement to carry the at least one data transaction request.

18. An apparatus of claim 11, wherein the apparatus is further caused to:
cause, at least in part, a processing of at least one account information associated with the at least one client account, the at least one courier account, or a combination thereof,
